(19) United States
(12) Patent Application Publication
(10) Pub. No.: US 2004/0223004 A1
(43) Pub. Date: Nov. 11, 2004

(54) System and method for implementing a landscape user experience in a hand-held computing device

(76) Inventors: Scott D. Lincke, San Carlos, CA (US); Timothy D. Twerdahl, Los Altos, CA (US)

Correspondence Address: CARR & FERRELL LLP, 2200 GENG ROAD, PALO ALTO, CA, 94303, US

(21) Appl. No.: 10/839,927

(22) Filed: May 5, 2004

Related U.S. Application Data
(60) Provisional application No. 60/468,316, filed on May 5, 2003.

(51) Int. Cl. G09G 5/00

(52) U.S. Cl. 345/649; 345/169; 345/650

(57) ABSTRACT

A hand-held computing device comprising a display and a processor is provided. The processor is configured to provide a graphical user interface on the display, the graphical user interface being switchable between a portrait mode and a landscape mode. An application running on the processor can generate a workspace to be displayed within the graphical user interface. In some embodiments, the workspace in the landscape mode is rotated 90° relative to the workspace in the portrait mode. The graphical user interface can also comprise a tool bar generated by an operating system running on the processor. In these embodiments, the tool bar location is switchable between left and right placement options. The landscape mode can also include left-hand-adjusted and right-hand adjusted configurations.

### CROSS-REFERENCE TO RELATED APPLICATIONS

This application claims the benefit of U.S. Provisional Patent Application Serial No. 60/468,316,

### filed May 5, 2003, entitled “System and Method for Implementing a Landscape User Experience in a Hand-Held Computing Device,” which is incorporated herein by reference in its entirety.

### BACKGROUND OF THE INVENTION

1. Field of the Invention

This invention relates generally to hand-held computing devices and more specifically to implementing a landscape-oriented user experience in a hand-held computing device.

2. Description of Background Art

Hand-held computing devices and software applications running on those devices often are designed for displaying graphical information to a user in a square display. Some hand-held computing devices, such as for gaming applications, have rectangular displays. A need exists, therefore, to optimize application outputs for hand-held devices with rectangular displays.

### SUMMARY OF THE INVENTION

The present invention provides a hand-held computing device comprising a display and a processor. The processor is configured to provide a graphical user interface on the display, the graphical user interface being switchable between a portrait mode and a landscape mode. In some embodiments, the display is rectangular. An application running on the processor can generate a workspace to be displayed within the graphical user interface. In some embodiments, the workspace in the landscape mode is rotated 90° relative to the workspace in the portrait mode. While the workspace produced by some applications is square, in some embodiments, a height and a width of the workspace in the landscape mode is different than the height and width of the workspace in the portrait mode.

The graphical user interface can also comprise a tool bar generated by an operating system running on the processor. In these embodiments, the tool bar location is switchable between left and right placement options. In further embodiments, the tool bar location is further switchable between a bottom placement option. In those embodiments that include the tool bar within the graphical user interface, the tool bar includes an icon, and the icon in the landscape mode is rotated 90° relative to the icon in the portrait mode.

The landscape mode, in some embodiments, can include a left-hand-adjusted configuration. In some of these embodiments, the workspace is proximate to a right side of the graphical user interface in the left-hand-adjusted configuration. The landscape mode can further includes a right-hand-adjusted configuration wherein the workspace is proximate to a left side of the graphical user interface. In those embodiments in which the graphical user interface includes a tool bar, the toolbar is disposed between the workspace and a left side of the graphical user interface in the left-hand-adjusted configuration. In some embodiments, the graphical user interface includes a square workspace and a rectangular workspace, and can also include a tool bar. In some embodiments, the arrangement of the workspaces and the tool bar within the graphical user interface are customizable by a user for both landscape and portrait modes.

### BRIEF DESCRIPTION OF THE DRAWINGS

FIG. 1 is a symbolic top view diagram of an exemplary hand-held computing device capable of displaying a graphical user interface that is switchable between a portrait mode and a landscape mode.

FIGS. 2-4 and 7-12 show the hand-held computing device of FIG. 1 as configured to present the landscape mode according to different embodiments of the present invention.

FIGS. 5 and 6 show the hand-held computing device of FIG. 1 as configured to present the portrait mode according to different embodiment of the present invention.

FIG. 13 is a schematic representation of an exemplary method for assembling content to be displayed in the graphical user interface of the hand-held computing device according to an embodiment of the present invention.

### DETAILED DESCRIPTION OF THE INVENTION

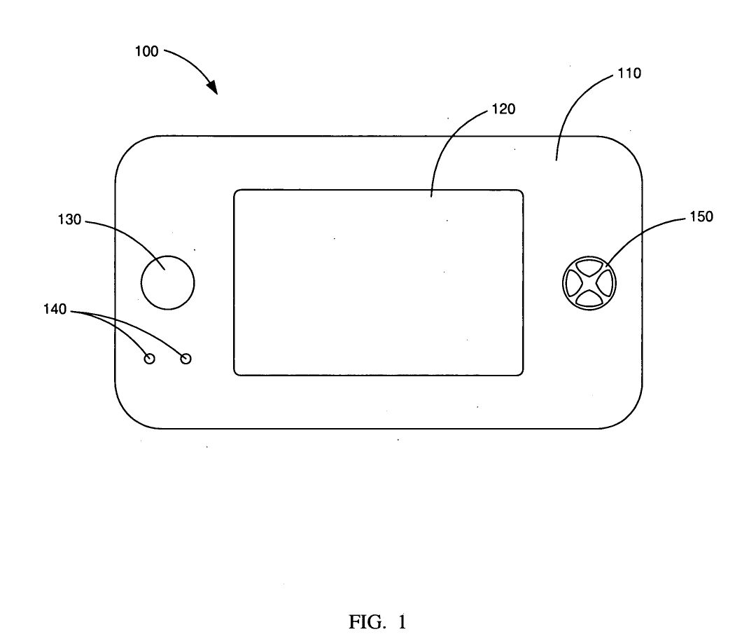

FIG. 1 is a symbolic top view diagram of an exemplary hand-held computing device 100 (e.g., a personal digital assistant (PDA), a gaming device, etc.) including a graphical user interface (GUI) through which a landscape user experience (described in detail below) can be implemented. The hand-held computing device 100 includes a housing 110 of suitable size and shape to be gripped by a user. A processor and associated circuitry (not shown) disposed within the housing 110 executes instructions associated with an operating system and one or more software applications. A generally rectangular display screen 120, secured to the housing 110, presents the GUI through which graphics and text are displayed to the user. It will be understood that although the present invention is described with respect to a hand-held device, the landscape user experience is not limited to hand-held devices.

The hand-held computing device 100 also comprises means for providing user input. For example, the hand-held computing device 100 can include an analog input device 130, and digital input devices 140 and 150. In the embodiment shown in FIG. 1, digital input devices 140 are simple push buttons, or the like, whereas digital input device 150 is a four-way digital switch. Additionally, the display screen 120, in some embodiments, is a touch sensitive input device. The hand-held computing device 100 can also include other well known features that have been omitted from FIG. 1 for clarity such as memory devices, expansion slots to receive memory cards or sticks, interfaces for attaching peripheral devices or other electronic devices, and so forth.

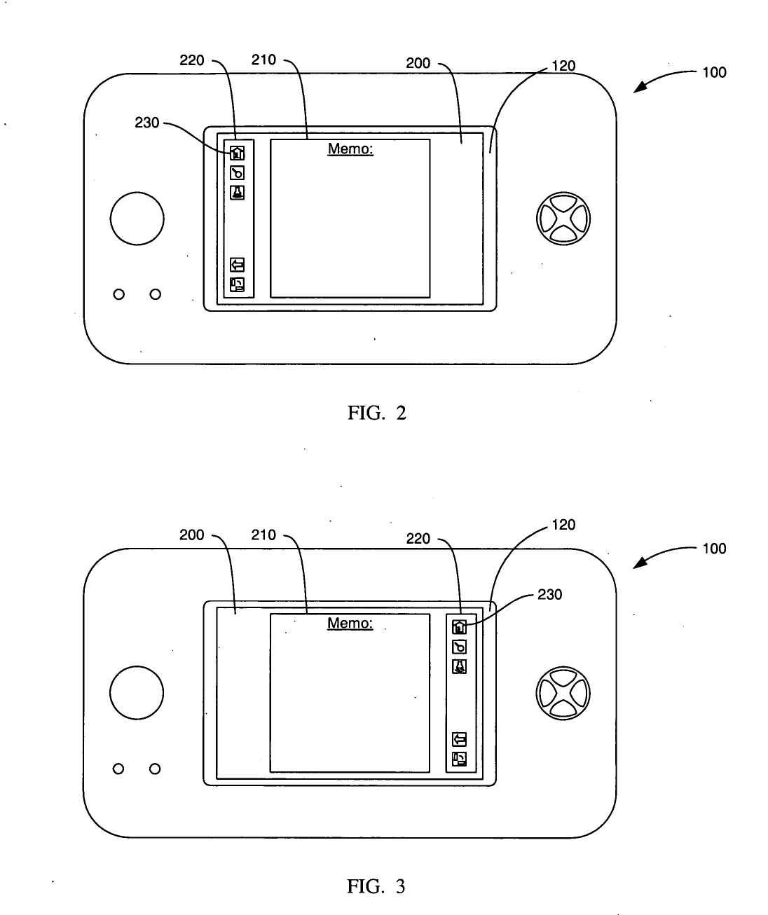

FIG. 2 illustrates the hand-held computing device 100 (FIG. 1) as configured to present the landscape mode through a GUI 200 displayed on the display screen 120 (FIG. 1), according to an embodiment of the present invention. The GUI 200 displays, for instance, a workspace 210 and a tool bar 220. The workspace 210 displays content generated by an application running on the processor of the hand-held computing device 100. The tool bar 220 can include icons 230 tied to specific functionalities of the operating system or of the application being executed by the processor. The user of the hand-held computing device 100 can trigger a specific functionality by selecting an appropriate icon 230 through one of the input means 120-150 (FIG. 1).

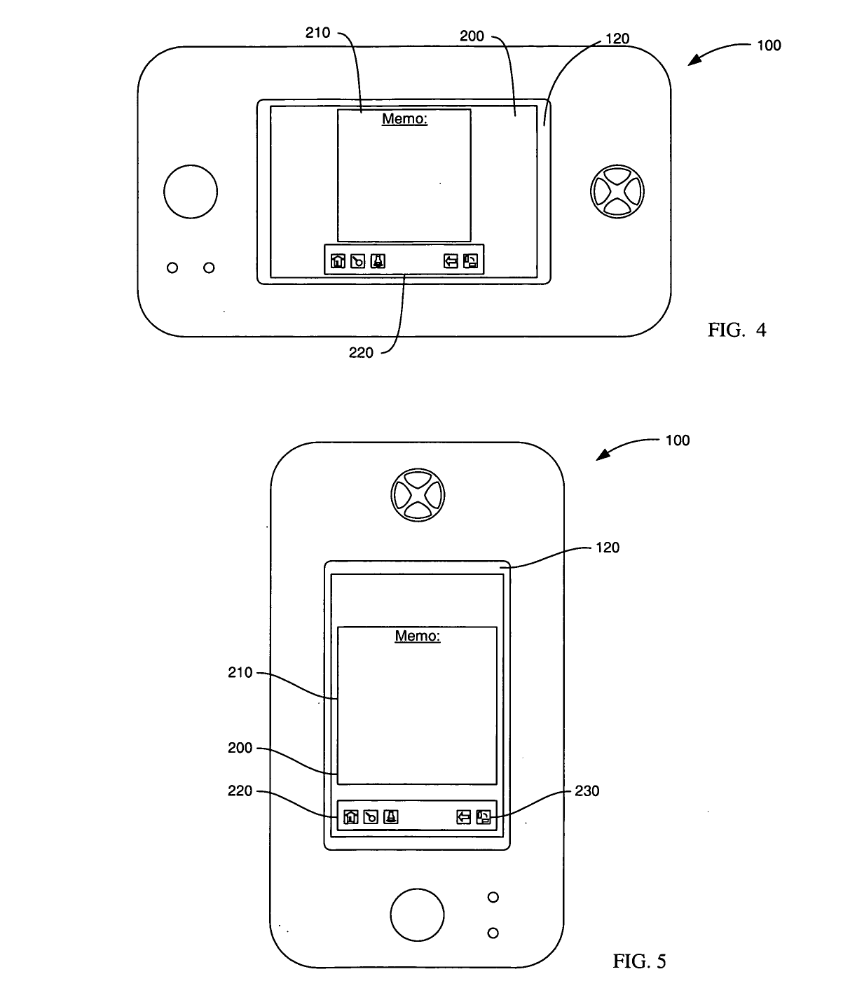

While the tool bar 220 is displayed to the left of the workspace 210 in FIG. 2, in FIG. 3 an alternative embodiment shows the tool bar 220 displayed to the right of the workspace 210. Together, FIGS. 2 and 3 illustrate left and right placement options for the tool bar 220. FIG. 4 shows a bottom placement option for the tool bar 220. It will be appreciated that the tool bar 220 can also be placed above the workspace 210 within the GUI 200 . In some embodiments, choosing the top or bottom placement options for the tool bar 220 causes the workspace 210 to be scaled down to allow sufficient room for the tool bar 220 to be either above or below the workspace 210 within the GUI 200 . Further, switching between left or right placement options and top or bottom placement options for the tool bar 220 causes the tool bar 220 to rotate by 90° relative to the frame of reference of the hand-held computing device 100. However, although the tool bar 220 undergoes the 90° rotation, the icons 230 maintain a fixed orientation. The icons 230 that were arranged top to bottom in FIGS. 2 and 3 can be arranged either left to right or right to left in FIG. 4.

FIG. 5 is an illustration of the hand-held computing device 100 as configured to present the portrait mode through the GUI 200 . From a comparison of FIGS. 2 and 5 it will be apparent that switching between landscape and portrait modes causes the workspace 210 to rotate through 90°. For example, switching from the landscape mode in FIG. 2 to the portrait mode in FIG. 3 causes the workspace 210 to rotate clockwise by 90° relative to the frame of reference of the hand-held computing device 100, and switching back to the landscape mode causes the workspace 210 to rotate counterclockwise by 90°. In some embodiments, the direction of rotation for each of these two transitions is reversed from the example just given.

From the comparison of FIGS. 2 and 5 it will also be apparent that switching between landscape and portrait modes does not necessarily cause the tool bar 220 to rotate, but the orientations of the icons 230 within the tool bar 220 do rotate through the same angle as the workspace 210. This is the case whether the tool bar 220 is displayed in the portrait mode above, below, to the left, or to the right, of the workspace 210.

In some embodiments, an icon 230 is configured to allow the user to select whether to display the GUI 200 in the landscape mode or the portrait mode. For example, selecting the icon 230 can toggle between the landscape and portrait modes. In other embodiments, each of the two modes has a dedicated icon 230 for selecting that mode. It will be understood that although icons 230 for selecting either landscape or portrait modes have been described in the context of the tool bar 220, such icons 230 can be located anywhere within the GUI 200. Further, the functionality of selecting either landscape or portrait modes, in some embodiments, is assigned to one of the input means 120-150 such as a digital input device 140. The desired mode can also be selected from a pull-down menu, in some embodiments.

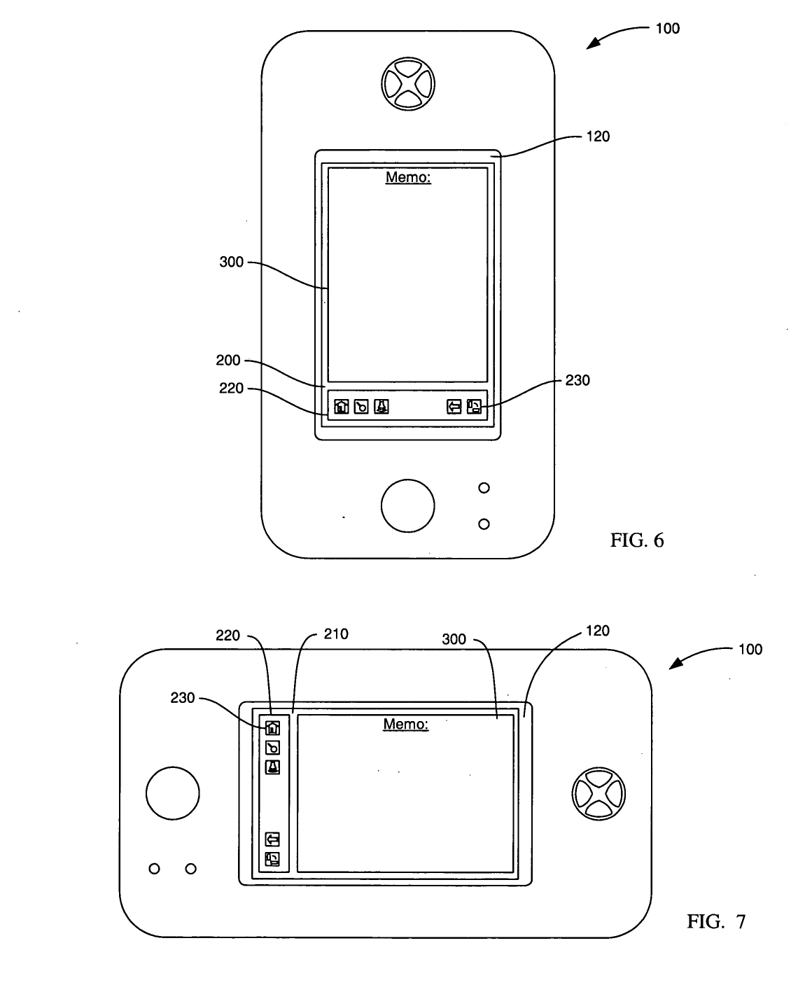

In the examples described above with respect to FIGS. 2-5 the GUI 200 is not fully utilized. While the workspace 210 for some applications is limited to a square area, not all applications are so limited. FIG. 6 is another illustration of the hand-held computing device 100 as configured to present the portrait mode through the GUI 200. It can be seen from a comparison of FIGS. 2 and 6 that some applications can provide a workspace 300 with different dimensions (i.e. height and width) in the portrait mode than in the landscape mode. FIG. 7 shows the workspace 300 as better fit to the landscape mode.

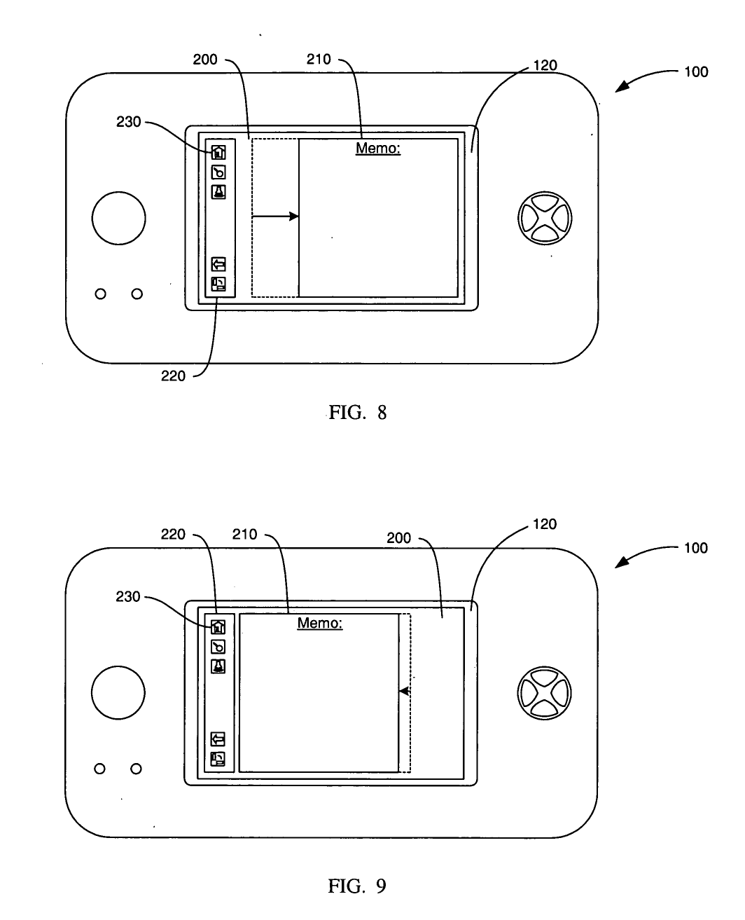

The invention also provides for adjustments to be made to the location of the workspace 210 (FIGS. 2-5) within the GUI 200. FIG. 8 illustrates a left-hand-adjusted landscape mode in which the location of the workspace 210 has been shifted to the right side of the GUI 200. Among other things, this shift allows a left-handed user of the application to access the workspace 210 with less visual interference from the user's left hand, thereby making the user's experience with the application less cumbersome. FIG. 9 illustrates a right-hand-adjusted landscape mode. In FIG. 9, because of the location of the tool bar 220, the workspace 210 is shifted to the left by a small amount.

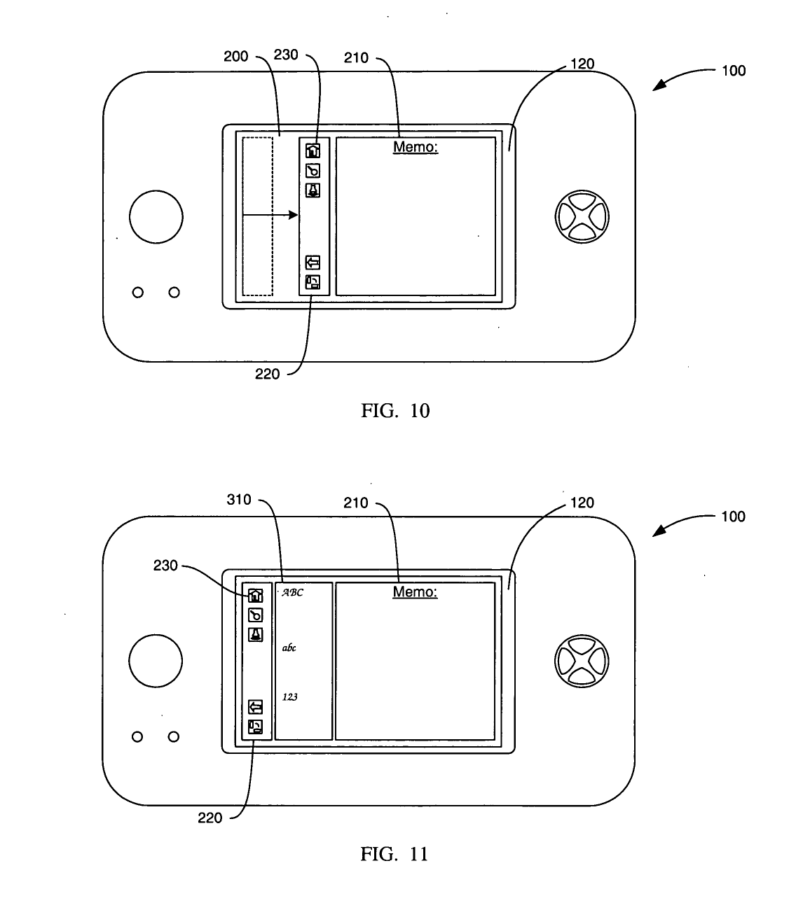

In some embodiments, switching between the right-hand-adjusted and the left-hand-adjusted landscape modes automatically switches which side of the GUI 200 the tool bar 220 is proximate to. Thus, if the workspace 210 is proximate to the left side of the GUI 200 (right-hand-adjusted mode), then the tool bar 220 is located proximate to the right side of the GUI 200, and vice versa. In still other embodiments, the tool bar 220 in the left-hand-adjusted landscape mode stays to the left of the workspace 210 but is shifted to the right away from the left edge of the GUI 200, as shown in FIG. 10. In this configuration the tool bar 220 can be said to follow the workspace 210. An analogous configuration can be readily implemented for a right-hand-adjusted landscape mode.

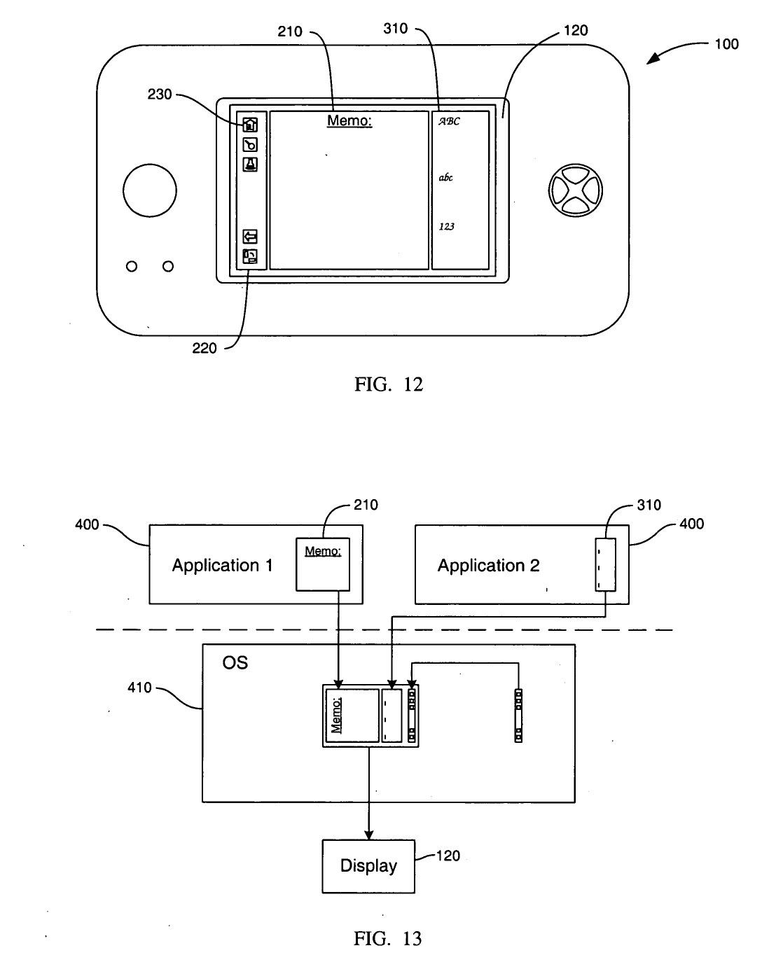

As noted above, the GUI 200 is not fully utilized in the examples described with respect to FIGS. 2-5. Another way in which to more fully utilize the area of the GUI 200 is to introduce a second workspace 310, preferably one that is rectangular and suited to the available area. An example, illustrated in FIG. 11, of an application that can use the workspace 310 is Graffiti (Trademark registered to Palm, Inc. on Jul. 11, 1995). The Grafitti application receives written user input from three areas within the workspace 310, provided that the display 120 (FIG. 1) is a touch sensitive input device. The three areas include an all-caps area, a lower case area, and a number area. Graffiti can be used, for example, as an alternative to a keyboard for entering text into various other applications. Like the icons 230, the three areas of workspace 310 rotate between the portrait and landscape modes. It will be apparent that the workspaces 210, 310 and tool bar 220 can be arranged in a number of permutations of which FIGS. 11 and 12 are but two examples.

It will be appreciated that making certain selections, such as selecting landscape or portrait modes, left or right placement options for the tool bar 220, left-hand-adjusted or right-hand-adjusted landscape modes, and whether or not to display workspaces 210 and 310, can be achieved in numerous different ways. Methods for making such selections include, for example, selecting an appropriate icon 230 through one of the input means 120-150 (FIG. 1), selecting a dedicated input means such as a dedicated digital input device 140, selecting a choice from a pull-down menu, and so forth.

Additionally, in some embodiments the user can set certain preferences, such as the placement of the tool bar 220 in various situations, as discussed above with respect to FIG. 10. For instance, in some embodiments the user can select, through a “preferences” or “customize” pull-down menu, that whenever the left-hand-adjusted landscape mode is selected, the tool bar 220 will follow the workspace 210, as shown in FIG. 10.

Further, in some embodiments, the hand-held computing device 100 (FIG. 1) can associate a configuration with an application. For example, the user can customize one application to always open in the portrait mode, and customize another application to always open in the landscape mode. Also, in some embodiments, a configuration associated with an application is a last configuration of the application when the application was previously closed. In order to retain a configuration associated with an application, the configuration can be stored to a memory device either internal to the hand-held computing device 100 or removable therefrom, such as a memory stick. Storing the configuration can be performed, for example, at the direction of the processor.

FIG. 13 schematically illustrates an exemplary method for assembling content to be displayed in the GUI 200 of the hand-held computing device 100. It can be seen in FIG. 13 that one or more applications 400 generate workspaces 210, 310 and provide workspaces 210, 310 to an operating system 410. The operating system 410 generates the GUI 200 and the tool bar 220. The operating system also populates the GUI 200 with the tool bar 220 and whichever workspaces 210, 310 are provided to it. The operating system 410 populates the GUI 200 with the workspaces 210; 310 and tool bar 220 according to the user settings for landscape or portrait mode, and the other display settings discussed herein. In some instances, the operating system rotates a workspace, such as workspace 210 in FIG. 13, by 90° so that the content therein is properly oriented for the user. As noted above, the tool bar 220 can be similarly rotated, and in some instances the orientation of the tool bar 220 remains fixed and each of the icons 230 are rotated by 90°.

Further, while some applications 400 (“legacy” applications) are only capable of providing a square workspace 210, other applications 400 can provide a workspace 300 that is tailored to available dimensions. In these embodiments, the application 400 can query the operating system 410 to determine the available dimensions for the workspace 300. Thereafter, the application 400 formats the workspace 300 according to the available dimensions and passes the workspace 300 to the operating system 410. The operating system 410 may then rotate the workspace 300 as necessary to correctly populate the GUI 200.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

1. A hand-held computing device comprising:
a display; and
a processor configured to provide a graphical user interface on the display, the graphical user interface being switchable between a portrait mode and a landscape mode.

2. The hand-held computing device of claim 1 wherein the display is rectangular.

3. The hand-held computing device of claim 1 wherein a workspace in the landscape mode is rotated 90° relative to the workspace in the portrait mode.

4. The hand-held computing device of claim 1 wherein the graphical user interface includes a workspace and a tool bar.

5. The hand-held computing device of claim 4 wherein, in the landscape mode, the tool bar location is switchable between left and right placement options.

6. The hand-held computing device of claim 5 wherein the tool bar location is further switchable between a bottom placement option.

7. The hand-held computing device of claim 4 wherein the workspace in the landscape mode is rotated 90° relative to the workspace in the portrait mode.

8. The hand-held computing device of claim 7 wherein the tool bar includes an icon, and the icon in the landscape mode is rotated 90° relative to the icon in the portrait mode.

9. The hand-held computing device of claim 3 wherein a height and a width of the workspace in the landscape mode is different than the height and width of the workspace in the portrait mode.

10. The hand-held computing device of claim 1 wherein the landscape mode includes a left-hand-adjusted configuration.

11. The hand-held computing device of claim 10 wherein the graphical user interface includes a workspace, and wherein the workspace is proximate to a right side of the graphical user interface in the left-hand-adjusted configuration.

12. The hand-held computing device of claim 10 wherein the landscape mode further includes a right-hand-adjusted configuration wherein the workspace is proximate to a left side of the graphical user interface.

13. The hand-held computing device of claim 11 wherein the graphical user interface further includes a tool bar.

14. The hand-held computing device of claim 13 wherein the toolbar is disposed between the workspace and a left side of the graphical user interface in the left-hand-adjusted configuration.

15. The hand-held computing device of claim 1 wherein the graphical user interface includes a square workspace and a rectangular workspace.

16. The hand-held computing device of claim 15 further comprising a tool bar.

17. The hand-held computing device of claim 1 further comprising a memory device.

18. The hand-held computing device of claim 17 wherein the processor stores a configuration for an application to the memory device.

19. The hand-held computing device of claim 18 wherein the configuration includes a last configuration for the application.
